(19) United States
(12) Patent Application Publication
(10) Pub. No.: US 2025/0361039 A1
(43) Pub. Date: Nov. 27, 2025

(54) METHODS, SYSTEMS BASED ON AN IOT LARGE MODEL, AND MEDIA FOR SMART CITY HIERARCHICAL EMERGENCY SUPERVISION

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/294,214

(22) Filed: Aug. 7, 2025

(30) Foreign Application Priority Data
Jun. 30, 2025 (CN) 202510890733.5

(51) Int. Cl. B64U 10/10; B64U 101/47; G16Y 40/10; G16Y 40/50

(52) U.S. Cl. CPC B64U 10/10; G16Y 40/10; G16Y 40/50; B64U 2101/47

(57) ABSTRACT

The present disclosure relates to a method, a system, and a storage medium for smart city hierarchical emergency supervision. The method includes: obtaining area information and emergency supervision data of a target management area corresponding to a low-level management platform, determining a first weighting factor for each type of emergency supervision sub-data of the at least one type of emergency supervision sub-data in the target management area based on the area information, determining a processing level for the each type of emergency supervision sub-data at the low-level management platform and a risk level of the target management area based on the first weighting factor, controlling the low-level management platform to process the emergency supervision data based on the processing level, determining patrol parameters for patrol device in the target management area based on the risk level, and controlling the patrol device to patrol according to the patrol parameters.

### CROSS-REFERENCE TO RELATED APPLICATION

This application claims priority of Chinese Application No. 202510890733.5, filed on Jun. 30, 2025, the entire contents of each of which are hereby incorporated by reference.

### TECHNICAL FIELD

The present disclosure relates to the technical field of smart city emergency supervision, and in particular, to methods, systems based on an Internet of Things (IoT) large model, and media for smart city hierarchical emergency supervision.

### BACKGROUND

With the development of the smart city, city emergency management also needs to be gradually improved. However, in the face of a large amount of emergency supervision data from different sources, how to prioritize the emergency of the emergency supervision data and correspondingly adjust the processing level of the emergency supervision data is a problem that needs to be solved.

Thereby, methods, systems based on an IoT large model, and media for smart city hierarchical emergency supervision are provided, which can accurately and efficiently improve the response speed of emergency events that are urgent and important.

### SUMMARY

Some embodiments of the present disclosure provide a method for smart city hierarchical emergency supervision. The method is implemented by a system for smart city hierarchical emergency supervision based on an Internet of Things (IoT) large model. The system includes: an emergency supervision user platform, an emergency supervision service platform, an emergency supervision management platform, an emergency supervision sensing network platform, and an emergency supervision object platform. The emergency supervision user platform includes a user terminal. The emergency supervision service platform includes a communication terminal. The emergency supervision management platform includes low-level management platforms and a high-level management platform. Each low-level management platform corresponds to one or more target management areas. The emergency supervision object platform includes a patrol device. The method is executed based on the high-level management platform and includes: obtaining area information and emergency supervision data of a target management area corresponding to a low-level management platform, determining a first weighting factor for each type of emergency supervision sub-data of at least one type of emergency supervision sub-data in the target management area based on the area information, determining a processing level for the each type of emergency supervision sub-data at the low-level management platform and a risk level of the target management area based on the first weighting factor, controlling the low-level management platform to process the emergency supervision data based on the processing level for the each type of emergency supervision sub-data, determining patrol parameters for the patrol device in the target management area based on the risk level, and controlling the patrol device to patrol along a patrol route at a patrol frequency according to the patrol parameters. The area information includes at least one of environmental information, production information, and life information. The emergency supervision data includes the at least one type of emergency supervision sub-data. The type of emergency supervision sub-data corresponds to a risk type. The first weighting factor represents an importance level of the corresponding type of emergency supervision sub-data in the target management area. The patrol parameters include the patrol route and the patrol frequency.

Some embodiments of the present disclosure provide a system for smart city hierarchical emergency supervision based on the IoT large model. The system includes an emergency supervision user platform, an emergency supervision service platform, an emergency supervision management platform, an emergency supervision sensing network platform, and an emergency supervision object platform. The emergency supervision user platform includes a user terminal. The emergency supervision service platform includes a communication terminal. The emergency supervision management platform includes low-level management platforms and a high-level management platform. Each low-level management platform corresponds to one or more target management areas. The emergency supervision object platform includes a patrol device. The high-level management platform is configured to: obtain area information and emergency supervision data of a target management area corresponding to a low-level management platform, determine a first weighting factor for each type of emergency supervision sub-data of at least one type of emergency supervision sub-data in the target management area based on the area information, determine a processing level for the each type of emergency supervision sub-data at the low-level management platform and a risk level of the target management area based on the first weighting factor; control the low-level management platform to process the emergency supervision data based on the processing level for the each type of emergency supervision sub-data; determine patrol parameters for the patrol device in the target management area based on the risk level; and control the patrol device to patrol along a patrol route at a patrol frequency according to the patrol parameters. The area information includes at least one of environmental information, production information, and life information. The emergency supervision data includes the at least one type of emergency supervision sub-data. The type of emergency supervision sub-data corresponds to the risk type. The first weighting factor represents an importance level of the corresponding type of the emergency supervision sub-data in the target management area. The patrol parameters include the patrol route and the patrol frequency.

Some embodiments of the present disclosure provide a non-transitory computer-readable storage medium. The storage medium stores computer instructions. When a computer reads the computer instructions in the storage medium, the computer executes the above method for smart city hierarchical emergency supervision.

### BRIEF DESCRIPTION OF THE DRAWINGS

The present disclosure is further described in terms of exemplary embodiments. The exemplary embodiments are described in detail by means of the drawings. These embodiments are not-limiting exemplary embodiments, in which the same numeral refers to the same structure.

FIG. 1 is a schematic diagram illustrating a platform structure of a system for smart city hierarchical emergency supervision based on an Internet of Things (IoT) large model according to some embodiments of the present disclosure.

FIG. 2 is an exemplary flowchart of a method for smart city hierarchical emergency supervision according to some embodiments of the present disclosure.

FIG. 3 is an exemplary schematic diagram for determining a processing level according to some embodiments of the present disclosure.

FIG. 4 is an exemplary flowchart of patrol control according to some embodiments of the present disclosure.

### DETAILED DESCRIPTION

In order to more clearly illustrate the technical solutions of the embodiments of the present disclosure, the drawings required to be used in the description of the embodiments are briefly described below. Obviously, the drawings in the following description are only some examples or embodiments of the present disclosure. It is possible for those skilled in the art to apply the present disclosure to other similar scenarios according to the drawings without creative labor. Unless obviously obtained from the context or described otherwise, the same numeral in the drawings refers to the same structure or operation.

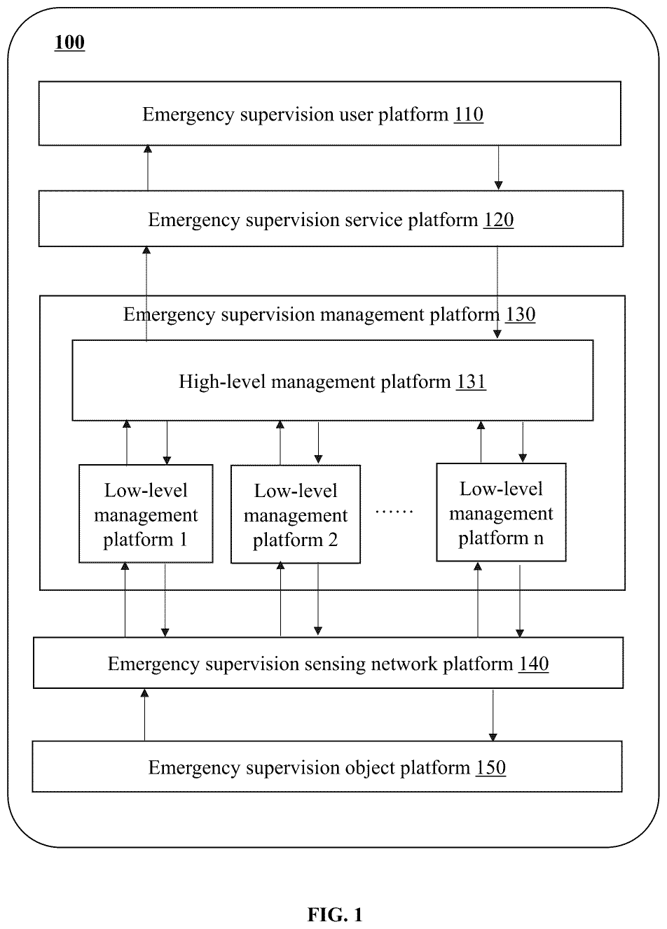

FIG. 1 is a schematic diagram illustrating a platform structure of a system for smart city hierarchical emergency supervision based on an Internet of Things (IoT) large model according to some embodiments of the present disclosure.

In some embodiments, as shown in FIG. 1, a system for smart city hierarchical emergency supervision 100 based on the IoT large model includes an emergency supervision user platform 110, an emergency supervision service platform 120, an emergency supervision management platform 130, an emergency supervision sensing network platform 140, and an emergency supervision object platform 150.

The emergency supervision user platform refers to a platform for the integrated coordination of emergency supervision by a high-level authority.

In some embodiments, the emergency supervision user platform includes a user terminal.

The user terminal refers to an external terminal device or an external system software. For example, the user terminal may be a mobile device, a computer, a device having input capabilities and/or output capabilities, or any combination thereof.

The emergency supervision service platform refers to an interactive service platform for receiving and transmitting emergency supervision data.

In some embodiments, the emergency supervision service platform interacts upwardly with the emergency supervision user platform and downwardly with the emergency supervision management platform.

In some embodiments, the emergency supervision service platform includes a communication terminal.

The communication terminal refers to a device or software that realizes real-time information interaction. For example, the communication terminal may be a wireless cell phone, a video monitor, a multimedia computer, etc.

The emergency supervision management platform refers to a comprehensive platform for processing and managing the emergency supervision data.

In some embodiments, the emergency supervision management platform includes a plurality of low-level management platforms and a high-level management platform 131.

The low-level management platform refers to a platform that stores and processes area information and the emergency supervision data.

In some embodiments, one low-level management platform may correspond to one or more target management areas.

The target management area refers to a management area corresponding to the low-level management platform that is currently processing data or information.

The high-level management platform refers to an integrated platform that coordinates the storing and processing of the data or the information uploaded by the low-level management platform.

In some embodiments, the high-level management platform may interact with the plurality of low-level management platforms. For example, a low-level management platform 1, a low-level management platform 2, . . . , or a low-level management platform n interacts with the high-level management platform, respectively.

The emergency supervision sensing network platform refers to a platform that transmits sensing data or information related to emergency supervision.

In some embodiments, the emergency supervision sensing network platform interacts upwardly with the plurality of low-level management platforms in the emergency supervision management platform and downwardly with the emergency supervision object platform.

In some embodiments, the emergency supervision sensing network platform includes a communication device (e.g., a routing gateway).

The emergency supervision object platform refers to a platform for collecting the emergency supervision data and implementing execution instructions.

In some embodiments, the emergency supervision object platform includes a patrol device.

The patrol device includes a manned patrol device, an unmanned patrol device, etc. The unmanned patrol device refers to an unmanned patrol vehicle, an unmanned aerial vehicle, etc., that replaces a man to patrol for routine projects. The routine projects may include taking pictures, etc. For example, the taken pictures may be pictures used to determine whether there is a fire or a flood.

In some embodiments, the routine projects may be performed by a monitoring apparatus configured on the unmanned patrol device. For example, the monitoring apparatus may include a data acquisition apparatus, a sensor, etc.

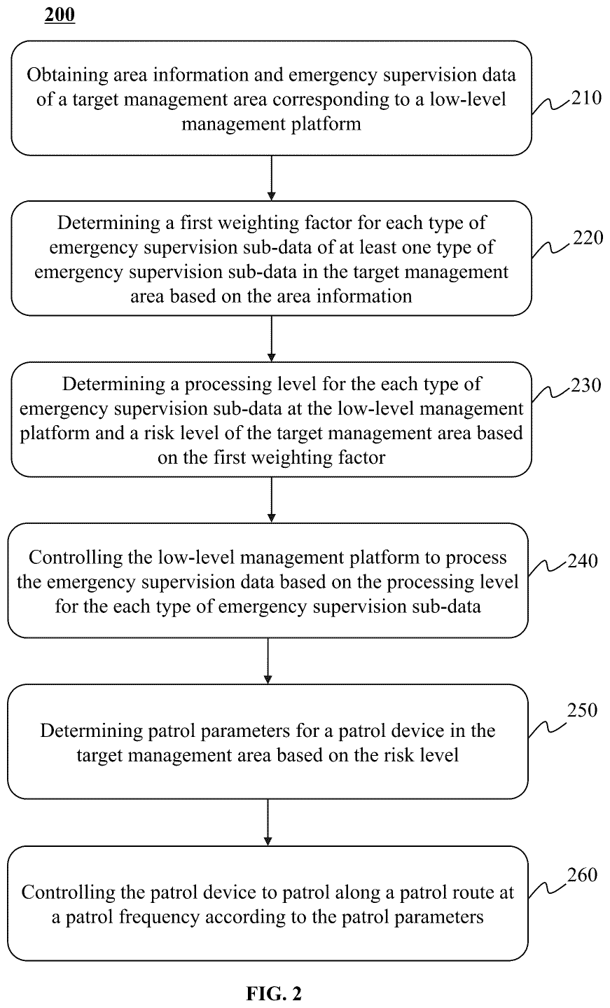

More descriptions regarding the system for smart city hierarchical emergency supervision based on the IoT large model and a method for smart city hierarchical emergency supervision may be found in related descriptions in FIG. 2-FIG. 4.

In some embodiments of the present disclosure, the system for smart city hierarchical emergency supervision based on the IoT large model can form a closed loop of information operation among functional platforms for coordinated and regular operation, and dynamically adjust the processing level of the emergency supervision data with high efficiency and precision to improve a processing efficiency in an emergency scenario.

FIG. 2 is an exemplary flowchart of a method for smart city hierarchical emergency supervision according to some embodiments of the present disclosure. As shown in FIG. 2, process 200 includes the following steps. In some embodiments, the process 200 may be performed by the high-level management platform 131.

In 210, area information and emergency supervision data of a target management area corresponding to a low-level management platform are obtained.

More descriptions regarding the target management area may be found in related descriptions in FIG. 1 in the present disclosure.

The area information refers to information related to the target management area. In some embodiments, the area information includes at least one of environmental information, production information, or life information.

The environmental information may reflect a sum of data, information, and conditions of a natural environment and an ecosystem within the target management area.

In some embodiments, the environmental information includes a natural geographic condition, a climatic characteristic, a natural resource condition, an ecosystem type, and environmental quality within the target management area.

In some embodiments, the production information includes industrial-related information, agricultural-related information, service industry-related information, etc. For example, the industrial-related information may include a type of factory, a count of the factories, a scale of the factory, etc. The agricultural-related information may include a type of a crop planted, an area of the crop planted, etc. The service industry-related information may include a type of food and beverage, a count of businesses in the tourism industry, etc.

The life information refers to information related to the lives of residents within the target management area.

In some embodiments, the life information includes demographic information, residence information, consumption information, etc.

In some embodiments, the high-level management platform may obtain the area information within the target management area by various means (e.g., a third-party website, a third-party system, or a third-party platform).

In some embodiments, the high-level management platform may also obtain the area information from a database of the low-level management platform via a network.

The emergency supervision data refers to data related to emergency preparedness and control (e.g., hydraulic data and temperature data). The emergency supervision data includes at least one type of emergency supervision sub-data, and one type of emergency supervision sub-data corresponds to one risk type.

The risk type refers to a type of risk that may exist within a management area. For example, the risk type includes a flood risk, a fire risk, a heat risk, a wind risk, a production risk, etc.

The emergency supervision sub-data refers to sub-data of the emergency supervision data divided based on the risk type. For example, the emergency supervision sub-data may include emergency supervision sub-data corresponding to the flood risk and emergency supervision sub-data corresponding to the fire risk.

In some embodiments, the emergency supervision data may include a plurality of pieces of emergency supervision sub-data.

The high-level management platform may obtain the emergency supervision data in various ways. For example, the high-level management platform may obtain the emergency supervision data from the database of the low-level management platform.

In 220, a first weighting factor for each type of emergency supervision sub-data of the at least one type of emergency supervision sub-data in the target management area is determined based on the area information.

The first weighting factor represents a corresponding importance level of a type of the emergency supervision sub-data in the target management area.

In some embodiments, a value in a range of 0-1 may be used to denote the first weighting factor. The larger the value of the first weighting factor is, the higher the importance level is.

In some embodiments, the high-level management platform may determine the first weighting factor via a first preset table.

The first preset table reflects the first weighting factors corresponding to a plurality of the environmental information, the production information, the life information, and types of the emergency supervision sub-data. The high-level management platform may determine the first weighting factor by querying the first preset table based on the environmental information, the production information, the life information, and the type of the emergency supervision sub-data. For example, a type of the emergency supervision sub-data is the fire risk, the environmental information shows that a forest coverage rate is 60%, the production information shows that there are a plurality of chemical factories in the management area, and the life information shows that a residential density is high, and the first weighting factor of the emergency supervision sub-data corresponding to the fire risk is determined as 0.9 by querying the first preset table.

In some embodiments, the first preset table may be set by a technician based on experience or historical data.

In some embodiments, the high-level management platform determining the first weighting factor for the each type of emergency supervision sub-data of the at least one type of emergency supervision sub-data in the target management area based on the area information includes: determining the first weighting factor for the each type of emergency supervision sub-data of the at least one type of emergency supervision sub-data in the target management area based on the area information of the target management area and area information of an associated management area of the target management area.

The associated management area refers to a region that is within a preset distance from a boundary of the target management area. In some embodiments, the preset distance may be set by the technician based on experience and a topographical condition surrounding the target management area.

For example, the preset distance may be 100 km.

In some embodiments, the associated management area includes area information and emergency supervision data corresponding to the associated management area. The area information and the emergency supervision data of the associated management area are similar to the area information and the emergency supervision data of the target management area. Details regarding the area information and the emergency supervision data of the associated management area may refer to related descriptions regarding the area information and the emergency supervision data of the target management area.

In some embodiments, the high-level management platform may determine the first weighting factor for the each type of emergency supervision sub-data in the target management area by constructing a risk correlation mapping and a graph model.

The risk correlation mapping refers to a mapping configured to reflect an impact relationship of risk type(s) in geographically adjacent management areas. The risk correlation mapping consists of nodes and edges.

The node of the risk correlation mapping may be the management area. Features of the node may include the environmental information, the production information, the life information, etc., in the management area.

The edge of the risk correlation mapping may include a directed edge connecting geographically adjacent management areas. A pointing of the directed edge indicates a pointing of a risk impact between the management area and its adjacent management area(s). There may be two directed edges if two adjacent management areas both have risk impacts on each other. For example, if a management area A and a management area B are adjacent management areas and the fire risk in the management area A and the management area B is bi-directional, with a risk incident (e.g., fire) in the management area A spreading to the management area B and a risk incident (e.g., fire) in the management area B spreading to the management area A, two directed edges are pointing in opposite directions between the management area A and the management area B.

An edge feature of each directed edge of the risk correlation mapping may be a risk propagation degree of a risk type on corresponding pointing.

The risk propagation degree refers to an impact degree of the risk type between the adjacent management areas. For example, if there is a flood risk in the management area B adjacent to the management area A, and there are a plurality of rivers in the management area B that flow into the management area A, the risk propagation degree of the flood risk in the management area B to the management area A is high.

In some embodiments, the risk propagation degree of two directions between two nodes may be different. For example, in the above example, the flood risk in the management area B has a high risk propagation degree to the management area A, but the flood risk in the management area A has a low risk propagation degree to the management area B.

In some embodiments, the risk propagation degree may be preset by the technician based on the historical data.

In some embodiments, the first weighting factor is also related to the risk propagation degree between the target management area and the associated management area. The risk propagation degree includes at least one sub-propagation degree. One sub-propagation degree corresponds to one risk type.

In some embodiments, the risk propagation degree is determined by a risk propagation model processing propagation-related information and the risk type. The risk propagation model is a machine learning model.

The sub-propagation degree refers to a propagation degree of the risk propagation degree divided based on the risk type. For example, the sub-propagation degree may be a flood risk propagation degree or a fire risk propagation degree.

The propagation-related information refers to factors associated with the propagation of risk from one management area to another management area.

In some embodiments, different risk types correspond to different propagation-related information. For example, the propagation-related information of a hydraulic risk type may be topographical terrain, river paths, etc., between the adjacent management areas. The propagation-related information of the fire risk type may be a wind direction, a distribution of combustibles (e.g., bush and buildings), etc., between the adjacent management areas. The propagation-related information of a power risk type is a distribution of power grids, etc., between the adjacent management areas.

The risk propagation model refers to a model configured to determine the risk propagation degree. In some embodiments, the risk propagation model may be a machine learning model. For example, the risk propagation model is a Convolutional Neural Networks (CNN) model, etc.

In some embodiments, an input of the risk propagation model may include the propagation-related information and the risk type. An output of the risk propagation model may be a sub-propagation degree corresponding to each input risk type. The sub-propagation degree may include a sub-propagation degree of the target management area to the associated management area and a sub-propagation degree of the associated management area to the target management area.

In some embodiments, the risk propagation model may be obtained through various training ways. For example, the risk propagation model may be obtained by training based on a plurality of training samples with training labels. The training samples may include sample propagation-related information and sample risk types corresponding to adjacent sample management areas. The training labels corresponding to the training samples are the sub-propagation degrees corresponding to each risk type corresponding to the adjacent sample management areas.

In some embodiments, the high-level management platform may determine, based on historical data, a plurality of sample propagation-related information and sample risk types used for training, and sample risk propagation degree corresponding to the training samples. The high-level management platform may determine an actual sub-propagation degree in the historical data when the risk incident corresponding to the risk type actually occurs in an adjacent management area as a label corresponding to the training sample.

In some embodiments, the actual sub-propagation degree may be determined based on a risk level and a propagation direction of the risk incident that has actually occurred in the adjacent sample management area. For example, if, in the historical data, an earthquake of magnitude 3 occurs in the management area A, and a magnitude of the earthquake that affects the management area B adjacent to the management area A is magnitude 2, the actual sub-propagation degree of the earthquake from the management area A to the management area B is ⅔.

In some embodiments, the high-level management platform may input sample propagation-related information and a sample risk type into an initial risk propagation model, construct a loss function based on a sub-propagation degree output by the initial risk propagation model and a training label corresponding to the sample propagation-related information and the sample risk type, and update the initial risk propagation model based on the loss function. When an end-of-training condition is met, a training of the initial risk propagation model is completed, and the trained risk propagation model is obtained. The end-of-training condition may be that the loss function converges, a count of iterations reaches a threshold, etc.

In some embodiments, the high-level management platform may designate a set of the sub-propagation degree corresponding to risk type(s) between the target management area and the associated management area as the risk propagation degree between the target management area and the associated management area, determine the edge feature of a corresponding edge in the risk correlation mapping based on the risk propagation degree between the target management area and the associated management area, and process the risk correlation mapping based on the graph model to determine the first weighting factor for the each type of emergency supervision sub-data in the target management area.

The graph model refers to a model configured to determine the first weighting factor. In some embodiments, the graph model may be a Graph Neural Network (GNN) model.

In some embodiments, an input to the graph model may include the risk correlation mapping and the risk type corresponding to the emergency supervision sub-data, and an output of the graph model may be a first weighting factor for each emergency supervision sub-data.

In some embodiments, the graph model may be obtained by various training ways. For example, the graph model may be obtained by training based on a plurality of training samples with training labels. The training sample may include a sample risk correlation mapping and a sample risk type corresponding to sample emergency supervision sub-data. The training label corresponding to the training sample is a first weighting factor for the sample emergency supervision sub-data.

In some embodiments, the high-level management platform may determine a plurality of sample risk correlation mappings and the sample risk types corresponding to the sample emergency supervision sub-data used for training based on the historical data, and determine the first weighting factor for the sample emergency supervision sub-data corresponding to the sample risk type based on an actual occurrence frequency and risk levels of risk incidents of a plurality of the risk types in each management area in the historical data. The first weighting factor is positively correlated with the actual occurrence frequency and the risk level.

The training process of the graph model is similar to that of the risk propagation model. More descriptions regarding the training way of the graph model may refer to the related descriptions regarding the training process of the risk propagation model.

According to some embodiments of the present disclosure, based on the propagation-related information and the risk types, the risk propagation model is utilized to calculate and obtain the sub-propagation degree corresponding to the each risk type, which allows for a more precise first weighting factor.

According to some embodiments of the present disclosure, determining the first weighting factor corresponding to the risk type in conjunction with the associated management area adjacent to the target management area may more comprehensively incorporate a risk brought to the target management area by the adjacent management area rather than merely considering risk factors of the target management area itself, which makes the first weighting factor more accurate.

In 230, a processing level for the each type of emergency supervision sub-data at the low-level management platform and a risk level of the target management area are determined based on the first weighting factor.

Different processing levels characterize different ways in which the emergency supervision sub-data is handled by the low-level management platform.

In some embodiments, different letters may be used to indicate the different processing levels. For example, the letters A, B, and C indicate the different processing levels. Merely by way of example, a processing level A indicates that the emergency supervision sub-data is uploaded directly to the high-level management platform without processing. A processing level B indicates pre-processing (e.g., filtering) the emergency supervision sub-data. A processing level C indicates processing the emergency supervision sub-data in different grades. The different grades correspond to different detailed levels of processing.

In some embodiments, the high-level management platform may determine the processing level based on a first preset relationship and the first weighting factor.

The first preset relationship refers to a relationship between the first weighting factor and the processing level. For example, a smaller first weighting factor indicates that the importance level of data is not high, the corresponding emergency supervision sub-data may be processed in more detail at the low-level management platform and a corresponding processing result may be transmitted to the high-level management platform. Relatively, a larger first weighting factor indicates that the importance level of the data is high, and the corresponding emergency supervision sub-data may be processed simply or not processed at the low-level management platform and uploaded to the high-level management platform for more detailed processing.

In some embodiments, the first preset relationship may be set by the technician based on experience.

The risk level refers to a comprehensive degree of a plurality of risks that the target management area is exposed to. For example, the risk level includes a comprehensive degree of drought risk, a fire risk, and a hot weather risk that the target management area is exposed to.

In some embodiments, the high-level management platform may weight and sum the first weighting factor for the each emergency supervision sub-data in the target management area, and take a weighted and summed value as the risk level of the target management area. A weighting coefficient of each first weighting factor may be preset.

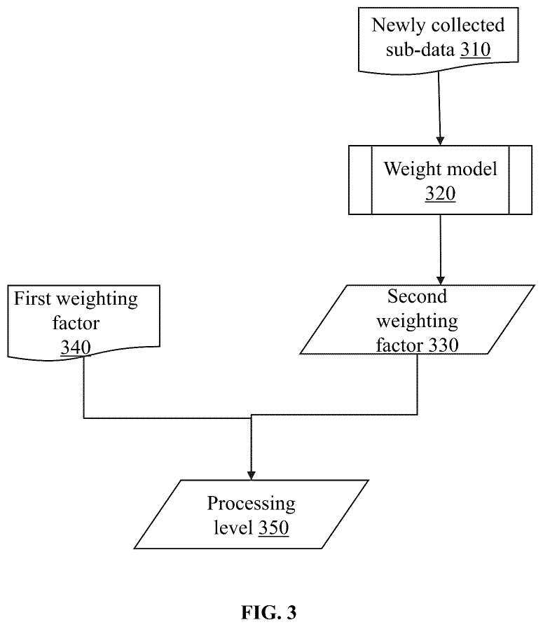

More descriptions regarding how to determine the processing level and the risk level may be found in related descriptions in FIG. 3.

In 240, the low-level management platform is controlled to process the emergency supervision data based on the processing level for the each type of emergency supervision sub-data.

In some embodiments, the high-level management platform may feed a calculated processing level of the each emergency supervision sub-data to the low-level management platform. The low-level management platform performs corresponding processing on the each emergency supervision sub-data based on the processing level. More descriptions regarding ways of processing may be found in related descriptions of step 230.

In 250, patrol parameters for the patrol device in the target management area are determined based on the risk level.

More descriptions regarding the patrol device may be found in related descriptions of FIG. 1.

The patrol parameters refer to parameters used when the patrol device patrols the target management area. The patrol parameters may include a patrol route and a patrol frequency.

The patrol route refers to a traveling route of the patrol device when the patrol device patrols the target management area.

The patrol frequency refers to a count of times the patrol device patrols the target management area per unit time.

In some embodiments, the high-level management platform may determine the patrol parameters based on a second preset relationship.

The second preset relationship refers to a corresponding relationship between the risk level and the patrol route and the patrol frequency.

In some embodiments, the second preset relationship may be set by the technician based on experience.

In some embodiments, the high-level management platform may determine the patrol route based on the risk level. For example, if the risk level in the target management area is high, the patrol route may be set densely. For example, the patrol route may include a main route and a branch path to reduce a probability of risk occurrence. If the risk level in the target management area is low, the patrol route may be set sparsely. For example, only the main route may be patrolled to reduce patrol consumption.

In some embodiments, the high-level management platform may determine the patrol frequency based on the risk level. For example, if the risk level in the target management area is high, the patrol frequency of the patrol device may increase. For example, the patrol frequency may be two patrols per day. If the risk level in the target management area is low, the patrol frequency of the patrol device may be reduced. For example, the patrol frequency may be once every three days or once a week.

In 260, the patrol device is controlled to patrol along the patrol route at the patrol frequency according to the patrol parameters.

In some embodiments, the high-level management platform may feed the patrol parameters to the low-level management platform, and the low-level management platform may set the patrol device to patrol according to the patrol parameters, so as to make the patrol device patrol according to the patrol parameters.

In some embodiments, the high-level management platform may directly control the patrol device via a network to perform an automatic parameter update on the patrol device so that the patrol device patrols according to the patrol parameters.

According to some embodiments of the present disclosure, based on the types of the emergency supervision data (e.g., the hydraulic risk and the fire risk) and in combination with the area information (e.g., the environmental information, the production information, and the life information) in the target management area, it is possible to confirm the impact degree of different types of the risks in the target management area more comprehensively by combining a plurality of factors, and further confirm the importance level of different types of the emergency supervision data, so that the low-level management platform processes the emergency supervision sub-data with low importance level in detail, and the emergency supervision sub-data with high importance level can be processed simply or uploaded directly to the high-level management platform for processing. The computing resource of the low-level management platform can be saved and the risk level in each management area can be coordinated by the high-level management platform, which can more rationally arrange security monitoring patrols to avoid an actual risk.

FIG. 3 is an exemplary schematic diagram for determining a processing level according to some embodiments of the present disclosure. As shown in FIG. 3, determining the processing level includes the following contents. In some embodiments, determining the processing level may be performed by the high-level management platform 131.

In some embodiments, a high-level management platform determines the processing level for each type of emergency supervision sub-data at a low-level management platform based on a first weighting factor 340, including: determining a processing level 350 for the each type of emergency supervision sub-data at the low-level management platform based on the first weighting factor 340 and a second weighting factor 330 for the each type of emergency supervision sub-data. The second weighting factor 330 for the each type of emergency supervision sub-data represents an urgency level of the each type of emergency supervision sub-data. The second weighting factor 330 for the each type of emergency supervision sub-data is determined by a weight model 320 processing newly collected sub-data 310 corresponding to the each type of emergency supervision sub-data. The weight model 320 is a machine learning model.

The second weighting factor reflects the urgency level of the corresponding emergency supervision sub-data.

The urgency level of the emergency supervision sub-data refers to an urgency degree of the emergency supervision sub-data that needs to be dealt with as soon as possible or an emergency level of corresponding risk situation.

In some embodiments, the emergency supervision sensing network platform or the emergency supervision object platform may determine the second weighting factor based on a weight model.

The weight model refers to a model configured to determine the second weighting factor. In some embodiments, the weight model may be a Neural Network (NN) model.

In some embodiments, an input of the weight model may include the newly collected sub-data corresponding to the each type of emergency supervision sub-data, and an output of the weight model may be the second weighting factor corresponding to the emergency supervision sub-data.

The newly collected sub-data refers to data obtained by sampling based on newly collected data. The newly collected sub-data is similar to the emergency supervision sub-data, and each newly collected sub-data corresponds to a risk type.

In some embodiments, the high-level management platform may designate newly collected emergency supervision sub-data under the risk type corresponding to the each emergency supervision sub-data as the newly collected data corresponding to the emergency supervision sub-data, and sample the newly collected data to obtain the newly collected sub-data. More descriptions regarding how to obtain the newly collected sub-data may be found in the related descriptions below.

In some embodiments, the weight model may be obtained by various training ways. For example, the weight model may be obtained by training a plurality of training samples with training labels. The training sample may include sample newly collected sub-data and a corresponding sample second weighting factor. The training label corresponding to the training sample is a sample actual risk level.

In some embodiments, the high-level management platform may determine the sample newly collected sub-data corresponding to a plurality of pieces of sample emergency supervision sub-data used for training based on historical data, and determine, based on a severity level of risk incident actually occurred corresponding to the sample newly collected sub-data corresponding to the sample emergency supervision sub-data in the historical data, a label corresponding to the training sample. For example, the more severe the risk incident actually occurred, the larger the value of the label.

The weight model is trained in a similar way as a risk propagation model. More descriptions regarding how the weight model is trained may refer to the related descriptions regarding how the risk propagation model is trained.

In some embodiments, the high-level management platform may determine the processing level of the emergency supervision sub-data based on a second preset table.

The second preset table is a table reflecting a relationship between a first weighting factor, the second weighting factor, and the processing level. The high-level management platform may determine the processing level of the corresponding emergency supervision sub-data by querying the second preset table based on values of the first weighting factor and the second weighting factor of the emergency supervision sub-data.

In some embodiments, the second preset table may be set by a technician based on experience.

In some embodiments, the newly collected sub-data is obtained by sampling newly collected data corresponding to the each type of emergency supervision sub-data using sampling parameters for the each type of emergency supervision sub-data.

In some embodiments, the newly collected data includes a plurality of pieces of newly collected sub-data, and the newly collected data corresponding to the each type of emergency supervision sub-data and the each type of emergency supervision sub-data share a same risk type.

In some embodiments, the sampling parameters for the each type of emergency supervision sub-data are related to historical occurrence characteristics of a target risk incident corresponding to the each type of emergency supervision sub-data in a target management area and an associated management area.

The newly collected data refers to data newly collected in a recent preset period. The newly collected data and the emergency supervision sub-data corresponding to the newly collected data belong to the emergency supervision sub-data in the same risk type. The recent preset period may be preset. For example, the recent preset period may be a recent historical 8 hours.

In some embodiments, the newly collected data may be obtained in various ways. For example, the newly collected data is obtained through a patrol device, or collected through a monitoring device (e.g., a gas monitoring device, a temperature monitoring device, etc.).

The sampling parameters refer to parameters in accordance with which the newly collected data corresponding to a type of emergency supervision sub-data is sampled.

In some embodiments, the sampling parameters include a sampling proportion, a sampling interval, and a sample size for sampling.

In some embodiments, the high-level management platform may determine the sampling parameters based on the target risk incident and the target management area corresponding to the each type of emergency supervision sub-data, and the historical occurrence characteristics of the associated management area adjacent to the target management area.

The target risk incident refers to an actual incident with the same risk type as the emergency supervision sub-data.

The historical occurrence characteristics refer to characteristics associated with the target risk incident. For example, the historical occurrence characteristics include a count of occurrences of the target risk incidents during a historical preset period and the severity level of the risk incident occurred every time.

In some embodiments, the target risk incident and the historical occurrence characteristics may be obtained from the historical data.

In some embodiments, the high-level management platform may determine the sampling parameters based on a third preset table.

The third preset table reflects a relationship between the target risk incident and the historical occurrence characteristics and corresponding sampling parameters. The high-level management platform may determine the sampling parameters by querying the third preset table based on a type, the count of occurrences, and scales of the target risk incidents that have occurred in history in the target management area and the associated management area.

For example, the high-level management platform may determine a sum of the count of times of the target risk incident occurred in the target management area and the count of times of the target risk incident occurred in the associated management area to obtain a first sum, and determine a sum of an occurrence level of the target risk incident occurred in the target management area (e.g., an earthquake magnitude and a wind level) and an occurrence level of the target risk incident occurred in the associated management area to obtain a second sum. The sampling parameters are determined by querying the third preset table based on the first sum and the second sum.

For example, the higher the count of occurrences and the larger the scale of the risk incident that occurred in the target management area and the associated management area, the larger the sampling proportion, the smaller the sampling interval, and the larger the sample size for sampling in the sampling parameters of the newly collected data corresponding to the emergency supervision sub-data.

According to some embodiments of the present disclosure, based on the target risk incident that occurred in history and the historical occurrence characteristics, it is possible to determine which type of risk occurs frequently in the target management area and the associated management area and the scale of the risk, and which type of the risk has a higher probability of occurrence. When a sampling of the newly collected data is guided, it is important to focus on the types of risk that have a higher probability of occurrence, which improves the accuracy of the second weighting factor.

In some embodiments, the sampling parameters are further related to a sub-propagation degree corresponding to the risk type of the target risk incident propagating from the associated management area to the target management area.

In some embodiments, the high-level management platform may calculate the first sum by an equation (1):

$${N}_{0} = {N}_{1} + \sum ( {k}_{i} * {n}_{i} ) ; \qquad ( 1 )$$

where N₀ denotes a sum count of occurrences (i.e., the first sum) of the target risk incidents in the target management area and the associated management area, N₁ denotes a count of occurrences of the target risk incidents in the target management area, nᵢ denotes a count of occurrences of the target risk incidents in an i-th associated management area, kᵢ denotes the sub-propagation degree corresponding to a target risk incident propagated from the i-th associated management area to the target management area. More descriptions regarding the sub-propagation degree may be found in related descriptions of FIG. 2.

In some embodiments, the high-level management platform may calculate the second sum by an equation (2):

$${H}_{0} = {H}_{1} + \sum ( {k}_{i} * {h}_{i} ) ; \qquad ( 2 )$$

where H₀ denotes a sum occurrence level (i.e., the second sum) of the target risk incidents in the target management area and the associated management area, H₁ denotes an occurrence level of the target risk incident in the target management area, hᵢ denotes an occurrence level of the target risk incident in the i-th associated management area, kᵢ denotes the sub-propagation degree corresponding to the target risk incident propagated from the i-th associated management area to the target management area.

According to some embodiments of the present disclosure, based on the sub-propagation degree from the associated management area to the target management area, the count of occurrence and the scale of occurrence of the target risk incident in the target management area and the associated management area are weighted and summed, respectively, which can fully consider the impact of the risk type of the associated management area on the target management area, make a calculation of the second weighting factor more accurate, and thereby obtaining a more accurate processing level of the emergency supervision sub-data.

In some embodiments, the high-level management platform determines the risk level of the target management area by determining the risk level of the target management area based on the first weighting factor and the second weighting factor for the each type of emergency supervision sub-data.

In some embodiments, the high-level management platform may determine the risk level in the target management area by an equation (3):

$$D = \sum ( {T}_{i} * {t}_{i} ) ; \qquad ( 3 )$$

where D denotes the risk level of the target management area, Tᵢ denotes a first weighting factor of emergency supervision sub-data of an i-th risk type in the target management area, tᵢ denotes a second weighting factor of the emergency supervision sub-data of the i-th risk type.

According to some embodiments of the present disclosure, when determining the risk level of an entire area, not only combining the occurrence likelihood of each type of risk in the entire area on a macro level but also combining the performance of real-time emergency supervision sub-data corresponding to a plurality of types of risk, make the risk level determined more accurate and closer to an actual situation.

According to some embodiments of the present disclosure, when determining the processing level of the emergency supervision sub-data in the target management area and the risk level of the entire area, not only the importance level of the emergency supervision sub-data corresponding to different risk types in the target management area is considered, but also the urgency level of the each type of emergency supervision sub-data is considered, which make the emergency supervision sub-data be processed more accurately and efficiently, thereby improving an efficiency of security prevention.

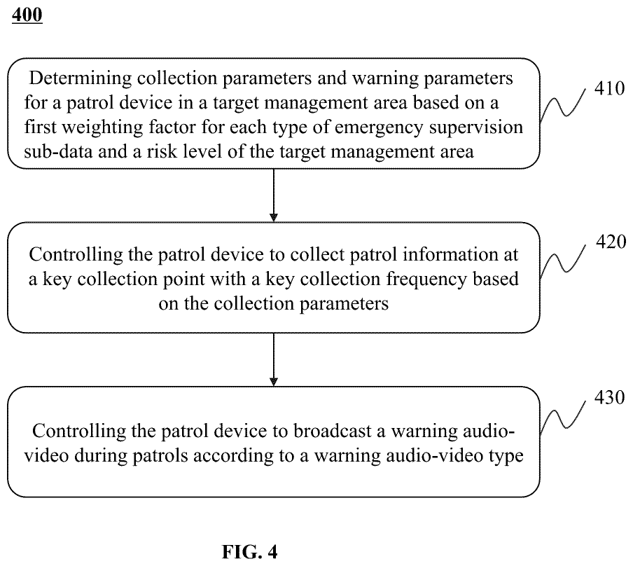

FIG. 4 is an exemplary flowchart of patrol control according to some embodiments of the present disclosure.

In some embodiments, as shown in FIG. 4, process 400 includes the following steps. In some embodiments, the process 400 may be performed by the high-level management platform.

In 410, collection parameters and warning parameters for a patrol device in a target management area are determined based on a first weighting factor for each type of emergency supervision sub-data and a risk level of the target management area.

More descriptions regarding the each type of emergency supervision sub-data, the first weighting factor, the target management area, the risk level, and the patrol device may be found in FIG. 1, FIG. 2, and related descriptions thereof.

The collection parameters refer to data that needs to be collected by the patrol device when the patrol device performs monitoring tasks. For example, the collection parameters may include a key collection point and a key collection frequency.

The key collection point refers to a high-risk monitoring area where the patrol device are required to prioritize data collecting. For example, when fire ranks as first of the first weighting factor, the key collection point may include points with high fire risk potential, such as chemical plants, etc.

In some embodiments, the key collection point may be determined in various ways. For example, the key collection point may be determined manually based on historical points of corresponding risks.

The key collection frequency refers to a frequency of data collection by the patrol device at the key collection point in a period of time.

In some embodiments, the key collection frequency may be determined based on the first weighting factor and the risk level. For example, the key collection frequency is proportional to the first weighting factor for a type of emergency supervision sub-data and the risk level of the target management area.

The warning parameters refer to a type of data that the patrol device alerts after recognizing a risk. For example, the warning parameters may include a warning audio-video type.

The warning audio-video type refers to an audio type and a video type used to alert residents to prevent the risk. The warning audio-video type may be determined based on the first weighting factor for the type of emergency supervision sub-data and the risk level of the target management area.

The risk types corresponding to different emergency supervision sub-data correspond to different warning audio-video types. The high-level management platform may determine the warning audio-video type based on the risk type corresponding to the emergency supervision sub-data with the largest first weighting factor. For example, when the risk type corresponding to the emergency supervision sub-data with the largest first weighting factor is fire, the warning audio-video type may be an audio and a video for preventing the fire.

The warning audio-video types corresponding to different risk levels are different. For example, the higher the risk level, the more the applied warning audio-video type corresponding to the risk level.

In 420, the patrol device is controlled to collect patrol information at the key collection point with the key collection frequency based on the collection parameters.

The patrol information refers to information collected by the patrol device during patrols. For example, the patrol information may include captured videos, captured pictures, etc. The patrol information may be used as emergency supervision data.

In 430, the patrol device is controlled to broadcast a warning audio-video during the patrols according to the warning audio-video type.

In some embodiments, the high-level management platform may control the patrol device to play a video for warning or broadcast a sound for warning based on a determined warning audio-video type of the patrol device.

In some embodiments, the high-level management platform may determine whether or not a fire has occurred based on the patrol information collected by the patrol device. In response to determining that the fire has occurred, the high-level management platform obtains a fire occurrence area and fire characteristics, and controls an unmanned aerial vehicle to spray an extinguishing agent corresponding to the fire characteristics in the fire occurrence area.

In some embodiments, the high-level management platform may determine whether or not the fire has occurred in various ways. For example, the patrol information is processed based on a preset algorithm to determine if there is a fire risk. The preset algorithm may be an image recognition, etc.

The fire occurrence area refers to an area where the fire occurs.

In some embodiments, the high-level management platform may determine the fire occurrence area based on a source of the patrol information that identifies the risk.

The fire characteristics may include no clear fire sources but black smoke, the fire source being a solid substance (e.g., paper or wood) or an oil-based substance, etc.

The extinguishing agent refers to a substance used to extinguish a fire. For example, the extinguishing agent may include water, a mixture of water and foam, dry powders, etc.

In some embodiments, the high-level management platform may construct a fourth preset table of the fire characteristics and the extinguishing agent based on historical experience. In the fourth preset table, the fire characteristics correspond to the extinguishing agent.

In some embodiments of the present disclosure, determining the fire occurrence area and the fire characteristics, and spraying corresponding extinguishing agents can extinguish fire rapidly and precisely, and avoid risks.

In some embodiments of the present disclosure, controlling the patrol device to play the warning audio-video during patrols based on the collection parameters and the warning parameters can efficiently remind the residents to guard against occurrences of high risks (e.g., fire).

Some embodiments of the present disclosure further provide a non-transitory computer-readable storage medium. The storage medium stores computer instructions. When a computer reads the computer instructions in the storage medium, the computer executes methods described in any of the above embodiments.

The basic concepts have been described above, and it is apparent to those skilled in the art that the foregoing detailed disclosure serves only as an example and does not constitute a limitation of the present disclosure. While not expressly stated herein, those skilled in the art may make various modifications, improvements, and amendments to the present disclosure. Those types of modifications, improvements, and amendments are suggested in the present disclosure, so the types of modifications, improvements, and amendments remain within the spirit and scope of the exemplary embodiments of the present disclosure.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Accordingly, the embodiments of the present disclosure are not limited to the embodiments expressly presented and described herein.

What is claimed is:

1. A method for smart city hierarchical emergency supervision, wherein the method is implemented by a system for smart city hierarchical emergency supervision based on an Internet of Things (IoT) large model;
the system includes: an emergency supervision user platform, an emergency supervision service platform, an emergency supervision management platform, an emergency supervision sensing network platform, and an emergency supervision object platform; wherein the emergency supervision user platform includes a user terminal, the emergency supervision service platform includes a communication terminal, the emergency supervision management platform includes low-level management platforms and a high-level management platform, each low-level management platform corresponding to one or more target management areas, the emergency supervision object platform includes a patrol device;
the method is executed based on the high-level management platform and comprises:
obtaining area information and emergency supervision data of a target management area corresponding to a low-level management platform, the area information including at least one of environmental information, production information, and life information, the emergency supervision data including at least one type of emergency supervision sub-data, a type of emergency supervision sub-data corresponding to a risk type;
determining a first weighting factor for each type of emergency supervision sub-data of the at least one type of emergency supervision sub-data in the target management area based on the area information, the first weighting factor representing an importance level of the corresponding type of emergency supervision sub-data in the target management area;
determining a processing level for the each type of emergency supervision sub-data at the low-level management platform and a risk level of the target management area based on the first weighting factor;
controlling the low-level management platform to process the emergency supervision data based on the processing level for the each type of emergency supervision sub-data;
determining patrol parameters for the patrol device in the target management area based on the risk level, the patrol parameters including a patrol route and a patrol frequency; and
controlling the patrol device to patrol along the patrol route at the patrol frequency according to the patrol parameters.

2. The method according to claim 1, wherein the determining a first weighting factor for each type of emergency supervision sub-data of the at least one type of emergency supervision sub-data in the target management area based on the area information includes:
determining the first weighting factor for the each type of emergency supervision sub-data of the at least one type of emergency supervision sub-data in the target management area based on the area information of the target management area and area information of an associated management area of the target management area.

3. The method according to claim 2, wherein the first weighting factor is related to a risk propagation degree between the target management area and the associated management area, the risk propagation degree including at least one sub-propagation degree, a sub-propagation degree corresponding to a risk type; and
the risk propagation degree is determined through a risk propagation model processing propagation-related information and the risk type, the risk propagation model being a machine learning model.

4. The method according to claim 1, wherein the determining a processing level for the each type of emergency supervision sub-data at the low-level management platform and a risk level of the target management area based on the first weighting factor includes:
determining the processing level for the each type of emergency supervision sub-data at the low-level management platform based on the first weighting factor and a second weighting factor for the each type of emergency supervision sub-data;
wherein the second weighting factor for the each type of emergency supervision sub-data represents an urgency level of the each type of emergency supervision sub-data, and the second weighting factor for the each type of emergency supervision sub-data is determined through a weight model processing newly collected sub-data corresponding to the each type of emergency supervision sub-data, the weight model being a machine learning model.

5. The method according to claim 4, wherein the newly collected sub-data is obtained by sampling newly collected data corresponding to the each type of emergency supervision sub-data using sampling parameters for the each type of emergency supervision sub-data, the newly collected data including a plurality of pieces of newly collected sub-data, the newly collected data corresponding to the each type of emergency supervision sub-data and the each type of emergency supervision sub-data sharing a same risk type; and
the sampling parameters for the each type of emergency supervision sub-data are related to historical occurrence characteristics of a target risk incident corresponding to the each type of emergency supervision sub-data in the target management area and an associated management area of the target management area.

6. The method according to claim 5, wherein the sampling parameters are further related to a sub-propagation degree corresponding to the risk type of the target risk incident propagating from the associated management area to the target management area.

7. The method according to claim 4, wherein the determining the risk level of the target management area includes:
determining the risk level of the target management area based on the first weighting factor and the second weighting factor for the each type of emergency supervision sub-data.

8. The method according to claim 1, wherein the method further comprises:
determining collection parameters and warning parameters for the patrol device in the target management area based on the first weighting factor for the each type of emergency supervision sub-data and the risk level of the target management area, the collection parameters including a key collection point and a key collection frequency, the warning parameters including a warning audio-video type;
controlling the patrol device to collect patrol information at the key collection point with the key collection frequency based on the collection parameters; and
controlling the patrol device to broadcast a warning audio-video during patrols according to the warning audio-video type.

9. The method according to claim 8, wherein the method further comprises:
determining whether or not a fire has occurred based on the patrol information collected by the patrol device;
in response to determining that the fire has occurred, obtaining a fire occurrence area and fire characteristics; and
controlling an unmanned aerial vehicle to spray an extinguishing agent corresponding to the fire characteristics in the fire occurrence area.

10. A system for smart city hierarchical emergency supervision based on an Internet of Things (IoT) large model, wherein the system comprises: an emergency supervision user platform, an emergency supervision service platform, an emergency supervision management platform, an emergency supervision sensing network platform, and an emergency supervision object platform; wherein the emergency supervision user platform includes a user terminal, the emergency supervision service platform includes a communication terminal, the emergency supervision management platform includes low-level management platforms and a high-level management platform, each low-level management platform corresponding to one or more target management areas, the emergency supervision object platform includes a patrol device;
the high-level management platform is configured to:
obtain area information and emergency supervision data of a target management area corresponding to a low-level management platform, the area information including at least one of environmental information, production information, and life information, the emergency supervision data including at least one type of emergency supervision sub-data, a type of emergency supervision sub-data corresponding to a risk type;
determine a first weighting factor for each type of emergency supervision sub-data of the at least one type of emergency supervision sub-data in the target management area based on the area information, the first weighting factor representing an importance level of the corresponding type of emergency supervision sub-data in the target management area;
determine a processing level for the each type of emergency supervision sub-data at the low-level management platform and a risk level of the target management area based on the first weighting factor;
control the low-level management platform to process the emergency supervision data based on the processing level for the each type of emergency supervision sub-data;
determine patrol parameters for the patrol device in the target management area based on the risk level, the patrol parameters including a patrol route and a patrol frequency; and
control the patrol device to patrol along the patrol route at the patrol frequency according to the patrol parameters.

11. The system according to claim 10, wherein the high-level management platform is further configured to:
determine the first weighting factor for the each type of emergency supervision sub-data of the at least one type of emergency supervision sub-data in the target management area based on the area information of the target management area and area information of an associated management area of the target management area.

12. The system according to claim 11, wherein the first weighting factor is related to a risk propagation degree between the target management area and the associated management area, the risk propagation degree including at least one sub-propagation degree, a sub-propagation degree corresponding to a risk type; and
the risk propagation degree is determined through a risk propagation model processing propagation-related information and the risk type, the risk propagation model being a machine learning model.

13. The system according to claim 10, wherein the high-level management platform is further configured to:
determine the processing level for the each type of emergency supervision sub-data at the low-level management platform based on the first weighting factor and a second weighting factor for the each type of emergency supervision sub-data;
wherein the second weighting factor for the each type of emergency supervision sub-data represents an urgency level of the each type of emergency supervision sub-data, and the second weighting factor for the each type of emergency supervision sub-data is determined through a weight model processing newly collected sub-data corresponding to the each type of emergency supervision sub-data, the weight model being a machine learning model.

14. The system according to claim 13, wherein the newly collected sub-data is obtained by sampling newly collected data corresponding to the each type of emergency supervision sub-data using sampling parameters for the each type of emergency supervision sub-data, the newly collected data including a plurality of pieces of newly collected sub-data, the newly collected data corresponding to the each type of emergency supervision sub-data and the each type of emergency supervision sub-data sharing a same risk type; and
the sampling parameters for the each type of emergency supervision sub-data are related to historical occurrence characteristics of a target risk incident corresponding to the each type of emergency supervision sub-data in the target management area and an associated management area of the target management area.

15. The system according to claim 14, wherein the sampling parameters are further related to a sub-propagation degree corresponding to the risk type of the target risk incident propagating from the associated management area to the target management area.

16. The system according to claim 13, wherein the high-level management platform is further configured to:
determine the risk level of the target management area based on the first weighting factor and the second weighting factor for the each type of emergency supervision sub-data.

17. The system according to claim 10, wherein the high-level management platform is further configured to:
determine collection parameters and warning parameters for the patrol device in the target management area based on the first weighting factor for the each type of emergency supervision sub-data and the risk level of the target management area, the collection parameters including a key collection point and a key collection frequency, the warning parameters including a warning audio-video type;
control the patrol device to collect patrol information at the key collection point with the key collection frequency based on the collection parameters; and
control the patrol device to broadcast a warning audio-video during patrols according to the warning audio-video type.

18. The system according to claim 17, wherein the high-level management platform is further configured to:
determine whether or not a fire is occurred based on the patrol information collected by the patrol device;
in response to determine that the fire has occurred, obtain a fire occurrence area and fire characteristics; and
control an unmanned aerial vehicle to spray an extinguishing agent corresponding to the fire characteristics in the fire occurrence area.

19. A non-transitory computer-readable storage medium, wherein the storage medium stores computer instructions, and when a computer reads the computer instructions in the storage medium, the computer executes the method for smart city hierarchical emergency supervision in claim 1.
